(19) United States
(12) Patent Application Publication
(10) Pub. No.: US 2021/0070019 A1
(43) Pub. Date: Mar. 11, 2021

(54) AUTOMOTIVE LAMINATE WITH INVISIBLE HEATING AND HIGH RED RATIO FOR CAMERA DEFROSTER

(71) Applicant: AGP America S.A., Ciudad de Panama (PA)

(72) Inventors: Mario Arturo MANNHEIM ASTETE, Lima (PE); Charles S. VOELTZEL, Lima (PE)

(21) Appl. No.: 17/042,766

(22) PCT Filed: Mar. 29, 2019
(86) PCT No.: PCT/IB2019/052637

§ 371 Date: Sep. 28, 2020

Related U.S. Application Data
(60) Provisional application No. 62/650,017, filed on Mar. 29, 2018.

(51) Int. Cl. B32B 17/10; H05B 3/86; B32B 17/06

(52) U.S. Cl. CPC B32B 17/10045; H05B 3/86; B32B 17/064; H05B 2203/013; B32B 17/10137; B32B 17/10385; B32B 17/10192

(57) ABSTRACT

The use of camera-based safety systems is growing at a rapid rate in automobiles where they provide lane departure warning, collision avoidance, adaptive cruise control and other functions. For proper operation, the cameras require a clear undistorted field of view. Keeping the camera area free of snow and ice has been a problem. The lines widths of printed silver frit defroster circuits can interfere with the camera function. Transparent conductive solar control coatings and films can be used but they often result is a poor red ratio. Thin embedded wire defrosters are invisible for all practical purposes but are expensive and difficult to connect electrically. The invention provides an invisible defroster circuit that can be inexpensively produced by applying the circuit to the inside surface of glass rather than imbedding within the laminate.

### FIELD OF THE INVENTION

This invention relates to the field of laminated automotive glazing.

### BACKGROUND OF THE INVENTION

The use of camera-based safety systems, requiring a wide field of view and a high level of optical clarity, is growing at a rapid rate. Camera based systems are used to provide a wide array of safety functions including adaptive cruise control, emergency braking, obstacle detection, lane departure warning and support for autonomous operation. A bright, clear, undistorted field of view and unaltered natural color are especially critical for camera-based systems to perform as intended. This is essential for these systems to be able to quickly classify and differentiate between objects, capture text, identify signage and signals, and to operate with minimal lighting.

As the industry moves towards full autonomous capability, the number of cameras and the resolution of the cameras are both increasing. The cameras require a high, forward looking field of view which must be kept clear of rain, snow and ice for the safety systems to work properly. Further, a full autonomous vehicle must have the field of view clear before the vehicle can be operated.

Therefore, the cameras are usually mounted in the path of the windshield wipers. The wipers provide adequate removal of water. Keeping the camera field of view clear of snow and ice is more difficult. The air from the hot air defroster system, which is typically used to clear the windshield, is blocked by the camera assembly. While some windshields are available with full surface transparent conductive coating or embedded wire resistive heating, the power density that these windshields operate at is not sufficient to provide for the rapid clearing that is needed to have a short drive-away time. Full surface heating also draws a substantial amount of power which may not be needed if just the camera field of view needs to be cleared. Further, the transparent conductive solar control films and coatings typically adapted for use as a heating element, often result in a poor red-ratio and must be removed from the camera field of view.

Electric heating circuits made with self-regulating positive temperature coefficient heating elements are one solution. They are mounted to the inside surface of the glass or incorporated into the camera assembly. But, as they are opaque, they cannot be placed in the camera field of view, are only effective when the camera field of view is small. This is due to the poor thermal conductivity of glass. The heating element separation distance can be no more than ˜35 mm Otherwise, the temperature rise between elements is not sufficient to clear the glass or the element temperature must be too high to compensate for the distance. Resistive heating circuits which encroach on the camera field of view are typically needed with multiple camera systems having a larger field of view.

There are two primary technologies used to produce these larger heated circuits: printed silver frit and embedded wire.

Silver frit is the most common type of heated circuit used for backlites, heated wiper rests and camera defrosters. It is also the most cost effective. Silver powder is mixed with carriers, binders and finely ground glass. Other materials are also sometimes added to enhance certain properties: the firing temperate, anti-stick, chemical resistance, etc. The silver frit is applied to the flat glass using a silk screen or ink jet printing process prior to the heating and bending of the glass. As the flat glass is heated during the bending process, the powdered glass in the frit softens and melts, fusing to the surface of the glass. The silver frit print becomes a permanent part of the glass. The frit is said to be “fired” when this takes place. This is a vitrification process which is very similar to the process used to apply enamel finishes on bathroom fixtures, pottery, china and appliances. Resistances as low as 2 milliohms per square and line widths as narrow as 0.5 mm are possible. The primary drawback to silver print is the aesthetics of the fired silver which has a dark orange to mustard yellow color depending upon which side of the glass it is printed on, the air side or the tin side. Busbars are printed silver but may be reinforced electrically with copper strips or braids. Screen print silver circuits cannot be used on the windshield in the driver field of view as the lines are too wide and would interfere with vision.

With a printed silver circuit, the maximum element spacing is ˜35 mm With a minimum line width of 0.5 mm it is not desirable to have any of the lines in the field of view but the restriction on spacing often requires that at least one line is in the field of view. Most camera systems can tolerate but it is not optimal.

On a windshield, the silver print is usually printed on the number four 104 surface of the inner glass layer 202 (FIG. 1A). The leads for the power connection are soldered to the printed silver frit.

An embedded wire resistive heated circuit is formed by embedding fine wires into the plastic bonding layer of a laminate. The wires are embedded in the plastic using heat or ultra-sound. Tungsten is a preferred material due to its tensile strength, which is 10× that of Copper and its flat black color. Heated windshields typically use tungsten wire that is in the 18-22 um range at which point the wires are virtually invisible. The wires are embedded using an oscillating sinusoidal like pattern to reduce glare that can occur under certain lighting conditions. For positions of the glazing other than the windshield, larger wire diameters can be used. Wires are typically embedded utilizing some sort of CNC machine. Thin flat copper is used for busbars with two layers being typically used. The first layer is applied to the plastic layer prior to the embedding of the wires. The second layer is applied over top of the first layer and the two are joined by soldering or using a conductive adhesive. For some applications it may only be required to use a single layer of copper. Of course, conductors other than copper can be used.

Embedded wire circuits can operate with wires as thin as 18 μm. At this diameter, they are virtually invisible to the camera system and do not present as much of a problem. At 18 μm, a typical spacing would be in the 3-6 mm range.

When an embedded wire circuit is inside of the laminate the power feed must be brought to the edge of glass and beyond. A typical approach is to use thin, 1-2 oz tinned copper strips as conductors and to wrap the copper strips in an insulator where it passes though the edge of glass. The thin copper strips are then bonded to a stranded copper wire which then terminates in a connector housing for connection to the vehicle wiring harness. Depending upon the current and dimensions needed, there are two methods used to fabricate this type of power feed. For higher current and longer lengths, separate copper strips are applied to an adhesive backed thin insulating substrate and then encapsulated by applying a second layer of insulating material, typically a poly-amide. For lower current and shorter lengths, a copper coated substrate is etched to form the feed circuit, in much the same was as a printed circuit is formed. In effect, these types of feeds are flexible printed circuits. This method is also used when more complex shapes are needed and when the conductor width is too thin to work with separate copper strips.

A panoramic windshield, with an extended top edge, is even more of a challenge due to the increased length of the lead required to reach from the camera area to the edge of glass. The lead is also more likely to be in a portion of the laminate where it will be visible and where any distortion will be found to be objectionable by the customer.

If the circuit is located a considerable distance from the edge of glass, as in the case of a panoramic windshield, then the length of the power feed must be increased to accommodate. The price of the power feed and the direct labor required to install it increases rapidly with length. If the feed passes through the daylight opening of the laminate, then aesthetics can also be an issue. It is generally necessary to hide the power feed for view. While this can be done with a black frit, black frit adds cost and decreases yield. The black frit also goes against the open airy aesthetic that a panoramic windshield is targeting.

The total thickness of the power lead must be less than the thickness of the plastic interlayer layers in total, preferably no more than one third of the total thickness. During the lamination process, the laminate is treated with heat and pressure. At the higher temperatures and pressure, the plastic interlayer will melt and flow to accommodate the thickness of the insert. If the lead is too thick, the laminate may fail.

Due to the variation in thickness of the laminate caused by the lead, the embedded power lead may produce reflected distortion in the glass. If the lead passes through the transparent portion of the laminate, transmitted distortion may also result.

Placement of the lead is done during the assembly of the laminate where it creates a bottleneck as it is labor intense to place the lead and to connect to the heated circuit. Full surface windshield heating is commonly provided thought the use of a conductive transparent coating. The coating is vacuum sputtered directly onto the glass and is comprised of multiple layers of metal and dielectrics. With resistances in the range of 2-6 ohms per square, a voltage convertor is needed to reach the power density required.

A transparent conductive coated film can also be used to provide for a resistive heated circuit. This is very similar too and made in the same manner that transparent conductive coated glass is made. A voltage convertor is needed to reach the power density required for windshield full surface heating. For the much smaller camera field of view, typically available coatings can be used with a 12-volt electrical system. Busbars are comprised of a conductive ink or thin flat copper conductors.

Full windshield defrosters based upon conductive coatings do not generally operate at a power level high enough to ensure the short drive away time required for full or semi-autonomous operation. They also share the same drawbacks as do embedded wire circuit with regard to the power connections. Further, solar control silver-based coating has a poor red-ratio.

Even a slight shift in color can cause a degradation in the performance of camera systems. The color red is especially important for vehicle camera systems as it is essential in recognizing, classifying and differentiating between signals and the other numerous light sources. Red ratio is the ratio of light (Tr) in the red portion of the spectrum (600 to 700 nm) to visible light (T) in the 440 to 700 nm range. The red ratio is defined at Tr/T. A certain minimum red ratio is required for the camera system to function properly.

Solar control IR reflecting coatings and films, even when they have high visible light transmission, often present a problem due to their higher reflection in the near IR red, resulting in a poor red ratio. Solar control glass compositions can also degrade the red ratio.

To work with most camera systems the coating or film must not be present in the camera field of view. This is accomplished by masking the field of view prior to coating or by deleting the coating after it has been applied. In the case of a film, it is accomplished by making a cutout in the film in the camera area. When a cutout is made, distortion near the edge of the film may result. Therefore, conductive coatings are not suitable for camera defrosting.

Heated transparent conductive coatings have the same issues with bus bars and power leads as wire embedded heating circuits.

Another technology is known as micro-mesh. A micro-mesh resistive heating circuit is comprised of very fine conductive lines which are deposited onto a non-conductive substrate such as glass or plastic using a vacuum sputtering technique to deposit a conductive material on the substrate. Patterns are formed by masking of the substrate using a lithographic process like that used to produce integrated circuits. Line widths of 10 um are possible, at which point, the mesh is invisible for all practical purposes. The primary advantage of this method is that the pattern can be designed to provide for very precise control of the heating. As the conductors do not need to be transparent, the thickness can be much greater than that which is possible when coating the entire substrate. Much greater control of the conductor thickness is possible than with screen printing or vacuum sputtered transparent conductive coating stacks. The process is also simpler as only a single metal layer is required. Busbars are also vacuum sputtered but can also be reinforced electrically by the addition of metal or conductive ink. Heated micro mesh has the same issues with bus bars and power leads as wire embedded heating circuits.

It would be desirable to reduce mitigate or altogether eliminate these drawbacks.

### BRIEF SUMMARY OF THE INVENTION

The drawbacks are overcome by laminating a resistive heating circuit to the inner surface of the laminate. The heated circuit can be produced by means of embedded wire, micro lithographic conductors or a conductive coating. The circuit is bonded to the glass surface by means of an adhesive layer, such as an optical adhesive, a conventional automotive interlayer film or a laminating resin. The circuit is protected by a thin layer of glass which may be chemically tempered and/or cold bent.

Advantages:
Lower cost
Simplifies power feed
Provides near invisible defrosting
Superior aesthetics
Superior optical properties
Uniform heating

### BRIEF DESCRIPTION OF DRAWINGS

These features and advantages of the present invention will become apparent from the detailed description of the following embodiments in conjunction with the accompanying drawings, wherein:

FIG. 1A shows a cross section of a typical automotive laminate.

FIG. 1B shows a cross section of a typical automotive laminate with coating and performance film.

FIG. 2 shows an exploded view of a micro-mesh on glass defroster.

FIG. 3 shows an exploded view of a transparent conductive coating defroster.

FIG. 4 shows an exploded view of an embedded wire defroster.

FIG. 5 shows an exploded view of a micromesh on film defroster.

FIG. 6 shows an exploded view of a transparent conductive film defroster.

FIG. 7 shows an exploded view of a non-uniform area with uniform micro mesh defroster.

FIG. 8 shows an exploded view of a windshield with laminated defroster on surface four.

### REFERENCE NUMERALS

4 Plastic bonding layer
6 Obscuration
8 Coating
12 Film
14 Busbar
16 Lead
18 Conductive coating
22 Embedded wire circuit
24 Micro mesh circuit
26 Adhesive layer
28 Cover
30 Plastic Film
32 Camera field of view
101 Surface one
102 Surface two
103 Surface three
104 Surface four
201 Exterior glass layer
202 Inner glass layer

### DETAILED DESCRIPTION OF THE INVENTION

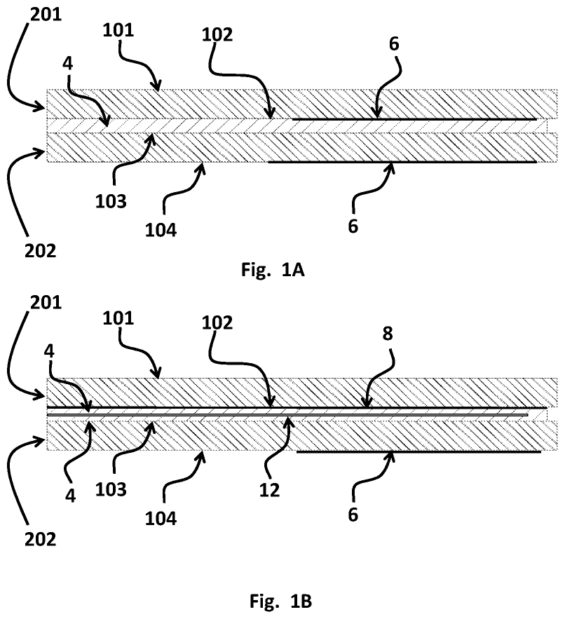

The following terminology is used to describe the laminated glazing of the invention. A typical automotive laminate cross section is illustrated in FIGS. 1A and 1B. The laminate is comprised of two layers of glass the exterior or outer 201 and interior or inner 202 that are permanently bonded together by a plastic bonding layer 4 (interlayer). The glass surface that is on the exterior of the vehicle is referred to as surface one 101 or the number one surface. The opposite face of the exterior glass layer 201 is surface two 102 or the number two surface. The glass surface that is on the interior of the vehicle is referred to as surface four 104 or the number four surface. The opposite face of the interior layer of glass 202 is surface three 103 or the number three surface. Surfaces two 102 and three 103 are bonded together by the plastic bonding layer 4. An obscuration 6 may be also applied to the glass. Obscuration are commonly comprised of black enamel frit printed on either the surface two 102 or number four surface 104 or on both. The laminate may also comprise a coating 8 on one or more of the surfaces. The laminate may also comprise a film 12 laminated between at least two plastic bonding layers 4.

Laminated safety glass is made by bonding two sheets of annealed glass together using a plastic bonding layer comprised of a thin sheet of transparent thermo plastic as shown in FIG. 1. Annealed glass is glass that has been slowly cooled from the bending temperature down through the glass transition range. This process relieves any stress left in the glass from the bending process. Annealed glass breaks into large shards with sharp edges. When laminated glass breaks, the shards of broken glass are held together, much like the pieces of a jigsaw puzzle, by the plastic bonding layer helping to maintain the structural integrity of the glass. A vehicle with a broken windshield can still be operated. The plastic bonding layer also helps to prevent penetration by objects striking the laminate from the exterior and in the event of a crash occupant retention is improved.

The glass layers are formed using gravity bending, press bending, cold bending or any other conventional means known in the art. Gravity and press bending methods for forming glass are well known in the art and will not be discussed in the present disclosure.

Cold bending is a relatively new technology. As the name suggest, the glass is bent, while cold to its final shape, without the use of heat. On parts with minimal curvature a flat sheet of glass can be bent cold to the contour of the part. This is possible because as the thickness of glass decreases, the sheets become increasingly more flexible and can be bent without inducing stress levels high enough to significantly increase the long-term probability of breakage. Thin sheets of annealed soda-lime glass, in thicknesses of about 1 mm, can be bent to large radii cylindrical shapes (greater than 6 m). When the glass is chemically, or heat strengthened the glass can endure much higher levels of stress and can be bent along both major axis. The process is primarily used to bend chemically tempered thin glass sheets (≤1 mm) to shape.

Cylindrical shapes can be formed with a radius in one direction of less than 4 meters. Shapes with compound bend, that is curvature in the direction of both principle axis can be formed with a radius of curvature in each direction of as small as approximately 8 meters. Of course, much depends upon the surface area of the parts and the types and thicknesses of the substrates.

The cold bent glass will remain in tension and tend to distort the shape of the bent layer that it is bonded to. Therefore, the bent layer must be compensated to offset the tension. For more complex shapes with a high level of curvature, the flat glass may need to be partially thermally bent prior to cold bending.

The glass to be cold bent is placed with a bent to shape layer and with a plastic bonding layer placed between the glass to be cold bent and the bent glass layer. The assembly is placed in what is known as a vacuum bag. The vacuum bag is an airtight set of plastic sheets, enclosing the assembly and bonded together it the edges, which allows for the air to be evacuated from the assembly and which also applies pressure on the assembly forcing the layers into contact. The assembly, in the evacuated vacuum bag, is then heated to seal the assembly. The assembly is next placed into an autoclave which heats the assembly and applies high pressure. This completes the cold bending process as the flat glass at this point has conformed to the shape of the bent layer and is permanently affixed. The cold bending process is very similar to a standard vacuum bag/autoclave process, well known in the art, except for having an unbent glass layer added to the stack of glass.

The plastic bonding layer (interlayer) has the primary function of bonding the major faces of adjacent layers to each other. The material selected is typically a clear plastic when bonding one glass layer to another glass layer. For automotive use, the most commonly used interlayer is polyvinyl butyl (PVB). In addition to polyvinyl butyl, ionoplast polymers, ethylene vinyl acetate (EVA), cast in place (CIP) liquid resin and thermoplastic polyurethane (TPU) can also be used. Interlayers are available with enhanced capabilities beyond bonding the glass layers together. The invention may include interlayers designed to dampen sound. Such interlayers are comprised whole or in part of a layer of plastic that is softer and more flexible than that normally used. The interlayer may also be of a type which has solar attenuating properties.

Automotive interlayers are made by an extrusion process. A smooth surface tends to stick to the glass, making it difficult to position on the glass and to trap air. To facilitate the handling of the plastic sheet and the removal or air (deairing) from the laminate, the surface of the plastic is normally embossed. Standard thicknesses for automotive PVB interlayer at 0.38 mm and 0.76 mm (15 and 30 mil).

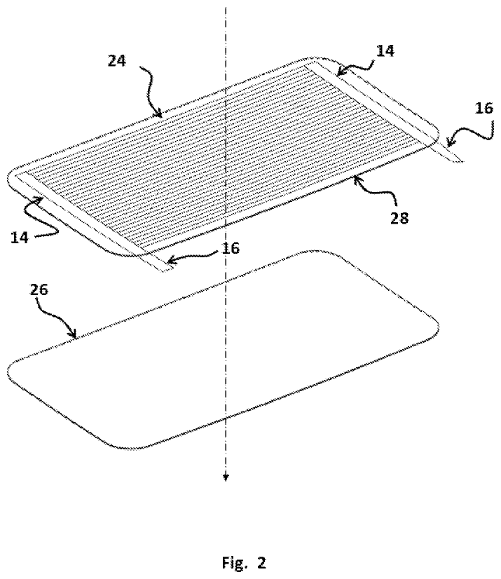

Rather than producing a defroster by means of a screen print silver on the number four surface or laminating an embedded wire, conductive coating or micro mesh circuit within the laminate, the defroster circuit is manufactured separate of the laminate and then bonded to the number four surface. The defroster circuit can be applied prior to lamination, depending upon the material used to bond the circuit or at any point afterwards. The defroster circuit may be bonded using an ordinary automotive interlayer, an optical adhesive, laminating resin or other suitable means. As shown in FIGS. 2, 3, 4, 5 and 6, the defroster circuit of the invention is comprised of at least one adhesive layer 26, at least one resistive circuit including busbars 14 and leads 16 and at least one cover 28. The cover 28 may be comprised of plastic, glass or any other suitable transparent material. The resistive circuit may be comprised of a micro mesh circuit 24, embedded wire circuit 22, printed silver, conductive coating 18 or conductive coated film (conductive coating 18 on a plastic film 30). Busbars are comprised of a conductive ink or thin flat copper conductors. The leads for the power connection are soldered to busbar. The resistive circuit is protected by the cover. The circuit is always between the major face of the cover (on the windshield side of the cover) and the windshield. The micro mesh or conductive coating may be deposited on a film, in which case two adhesive layers are required or directly on the cover. The cover may be comprised of thin glass. The cover may be comprised of a chemically tempered glass. The cover may be bent to the curvature of the windshield. The cover may be partially bent or applied flat and flat bent.

In addition to the conventional automotive interlayers, optically clear adhesives (OCA) might also be applied as adhesive elements for fixing the heating element in the windshield. These adhesives are formed by partially curing optically clear resins (OCR) at ˜70° C. and forming pliable films that also have some level of adherence. These films may be comprised of acrylics, epoxy resins, silicones, and urethanes disposed in such way that they are compatible with the surfaces to be bonded. Then, by assembling the elements into the laminated windshield, vacuum is applied in order to assure an effective bonding process. After, curing means, such as UV, thermal, electrons, and moisture is applied for forming the final laminated windshield with heating element Laminating resins also consist of these same adhesive materials but in a liquid state. Their application consists of the same steps as that of optically clear adhesives. Both solutions may also be applied depending on how compatible the surfaces to be bonded are with these adhesives.

### DETAILED DESCRIPTION OF THE EMBODIMENTS

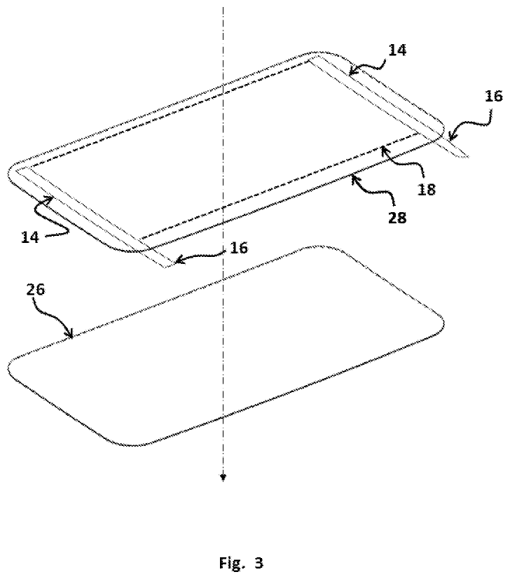

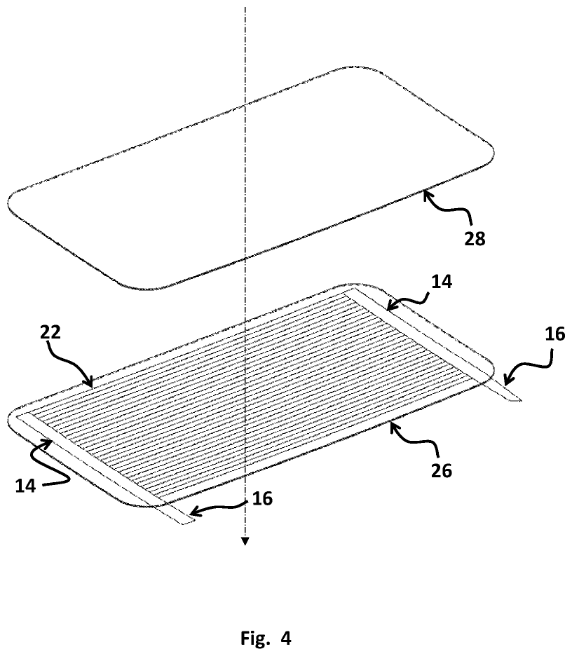

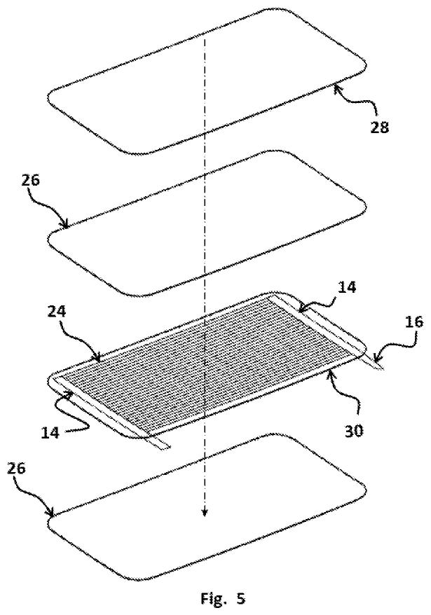

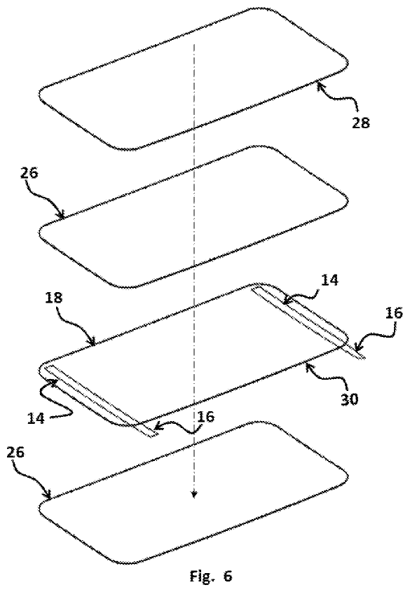

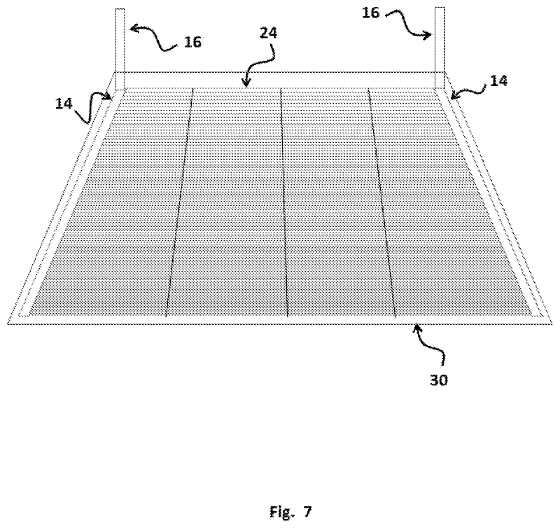

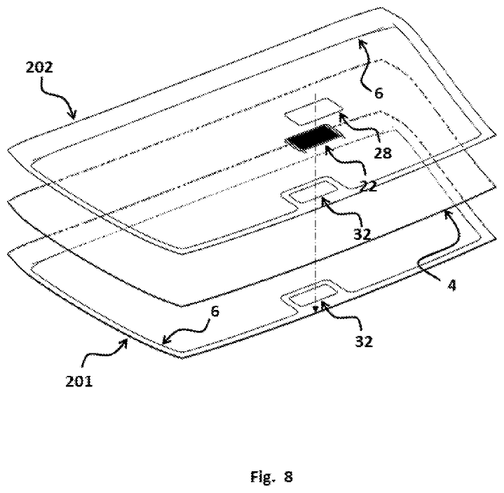

1. A windshield, similar to the one illustrated in FIG. 8, has an opening for the camera field of view 32, in the black obscuration 6, that has a trapezoidal shape of approximately 90 mm at the top by 180 mm along the bottom and a height of 110 mm for a heated area of ˜1.5 dm2. The defroster circuit is designed to have a power density of at least 15 watts/dm2. With a heated area of 1.5 dm2 the minimum power must be 22.5 watts. The supply voltage is 13 volts.
   The laminate has a standard soda-lime 2.5 mm thick clear exterior glass layer 201 and 2.1-mm soda-lime solar green interior glass layer 202. Obscuration 6 is screen printed on surface two and surface four. The obscuration 6 frames the camera field of view 32 area and hides the camera assembly. The glass layers are thermally bent using a gravity bending process.
   In this embodiment, the defroster circuit comprises a micro-mesh circuit 24, as show in FIG. 7, comprising 10 μm lines designed to meet the electrical requirements. The thickness of the lines is controlled so as to meet the power requirements. The trapezoidal design results in the lines at the top having a lower resistance and drawing more power that the ones located at the bottom. To compensate the spacing between the lines is varied in a manner that is directly proportional to their power. This results in uniform power density from top to bottom. The mesh is also provided with vertical lines. During normal operation, little if no current will flow in the vertical lines as the voltage will be balanced. If a line should fail, the vertical lines provide a measure of fault tolerance as the power will have an alternate route around the break. The vertical lines will also help to balance the power in the circuit if there is any variation in line width or thickness, due to manufacturing variation and tolerance.
   During assembly of the laminate, as shown in FIG. 5, a layer of 0.36 mm PVB (adhesive layer) 26 is placed on the number four surface of the laminate followed by the micro-mesh circuit 24 deposited on 50 μm PET plastic film 30, another 0.36 layer of PVB (adhesive layer) 26 and then an 0.4 mm chemically tempered aluminosilicate flat glass cover 28. The flat glass cover 28 is cold bent in the autoclave. The assembled laminated is processed, using standard automotive laminating equipment.
2. The windshield, similar to the one illustrated in FIG. 8, has a rectangular opening for the camera field of view 32, in the black obscuration 6, that top by 200 mm wide and a height of 100 mm for a heated area of ˜2 dm2 The defroster circuit is designed to have a power density of at least 15 watts/dm2. With a heated area of 1.5 dm2 the minimum power must be 30 watts. The supply voltage is 13 volts.
   The laminate has a standard soda-lime 2.5 mm thick clear exterior glass layer 201 and 2.1-mm soda-lime solar green interior glass layer 202. Obscuration 6 is screen printed on surface two and surface four. The obscuration 6 frames the camera field of view 32 area and hides the camera assembly. The glass layers are thermally bent using a gravity bending process.
   In this embodiment, the defroster circuit comprises a micro-mesh circuit 24, as show in FIG. 2 comprising 10 μm lines, designed to meet the electrical requirements. The thickness of the lines is controlled so as to meet the power requirements. The rectangular design allows for uniform line spacing. This results in uniform power density from top to bottom.
   During assembly of the laminate, as shown to FIG. 2, a layer of 0.36 mm PVB (adhesive layer) 26 is placed on the number four surface of the laminate followed by the micro-mesh circuit 24, deposited on an 0.4 mm chemically tempered aluminosilicate flat glass cover 28. The flat glass cover 28 is cold bent in the autoclave. The assembled laminated is processed, using standard automotive laminating equipment.
3. The windshield, similar to the one illustrated in FIG. 8, has a rectangular opening for the camera field of view 32, in the black obscuration 6, that top by 200 mm wide and a height of 100 mm for a heated area of ˜2 dm2 The defroster circuit is designed to have a power density of at least 15 watts/dm2. With a heated area of 1.5 dm2 the minimum power must be 30 watts. The supply voltage is 13 volts.
   The laminate has a standard soda-lime 2.5 mm thick clear exterior glass layer 201 and 2.1-mm soda-lime solar green interior glass layer 202. Obscuration 6 is screen printed on surface two and surface four. The obscuration 6 frames the camera field of view 32 area and hides the camera assembly. The glass layers are thermally bent using a gravity bending process.
   In this embodiment, the defroster circuit comprises a transparent conductive coated film, as show in FIG. 6, designed to meet the electrical requirements. The coating stack selected does not attenuate red.
   During assembly of the laminate, as shown in FIG. 6, a layer of 0.36 mm PVB (adhesive layer) 26 is placed on the number four surface of the laminate followed by the transparent conductive coating 18, deposited on 50 μm PET plastic film 30, another 0.36 layer of PVB (adhesive layer) 26 and then an 0.4 mm chemically tempered aluminosilicate flat glass cover 28. The flat glass cover 28 is cold bent in the autoclave. The assembled laminated is processed, using standard automotive laminating equipment.
4. The windshield, similar to the one illustrated in FIG. 8, has a rectangular opening for the camera field of view 32, in the black obscuration 6, that top by 200 mm wide and a height of 100 mm for a heated area of ˜2 dm2 The defroster circuit is designed to have a power density of at least 15 watts/dm2. With a heated area of 1.5 dm2 the minimum power must be 30 watts. The supply voltage is 13 volts.
   The laminate has a standard soda-lime 2.5 mm thick clear exterior glass layer 201 and 2.1 mm soda-lime solar green interior glass layer 202. Obscuration 6 is screen printed on surface two 102 and surface four of the laminate. The obscuration 6 frames the camera field of view 32 area and hides the camera assembly. The glass layers are thermally bent using a gravity bending process.
   In this embodiment, the defroster circuit comprises a transparent conductive coating 18 deposited on the cover 28, as shown in FIG. 3. The coating stack selected does not attenuate red.
   During assembly of the laminate a layer of 0.36 mm PVB (adhesive layer) 26 is placed on the number four surface of the laminate followed by the transparent conductive coated 0.4 mm chemically tempered aluminosilicate flat glass cover 28. The flat glass cover 28 is cold bent in the autoclave. The assembled laminated is processed, using standard automotive laminating equipment.
5. The windshield, similar to the one illustrated in FIG. 8, has a rectangular opening for the camera field of view 32, in the black obscuration 6, that top by 200 mm wide and a height of 100 mm for a heated area of ˜2 dm2 The defroster circuit is designed to have a power density of at least 15 watts/dm2. With a heated area of 1.5 dm2 the minimum power must be 30 watts. The supply voltage is 13 volts.
   The laminate has a standard soda-lime 2.5 mm thick clear exterior glass layer 201 and 2.1-mm soda-lime solar green interior glass layer 202. Obscuration 6 is screen printed on surface two 102 and surface four of the laminate. The obscuration 6 frames the camera field of view 32 area and hides the camera assembly. The glass layers are thermally bent using a gravity bending process.
   In this embodiment, the defroster circuit comprises an embedded wire circuit 22 designed to meet the power requirements using an 18 μm tungsten wire which is embedded in a 0.76 layer of PVB (adhesive layer) 26.
   During assembly of the laminate, as shown in FIG. 4, wire embedded PVB is placed on the number four surface of the laminate followed by the 0.4 mm chemically tempered aluminosilicate flat glass cover 28. The flat glass cover 28 is cold bent in the autoclave. The assembled laminated is processed, using standard automotive laminating equipment.

In some embodiments (not shown in figures), a laminated glazing with a camera field of view comprises an exterior and an interior glass layers, wherein the interior glass layer has a cutout in the camera field of view. The laminated glazing further comprises a plastic bonding layer located between the exterior and the interior glass layers, a resistive heating circuit configured to heat at least a portion of the camera field of view, and a transparent glass cover that fits within said cutout; wherein the resistive heating circuit is located between the transparent glass cover and the exterior glass layer. Additionally, in several embodiment, the transparent glass cover may be bonded to the exterior glass layer by means of said at least one plastic bonding layer. In some preferred embodiments, the laminated glazing further comprises at least one adhesive layer, wherein said at least one plastic layer has a cut out in the camera field of view, and wherein the transparent glass cover is bonded to the exterior glass layer by means of said at least one adhesive layer.

1. A laminated glazing with a camera field of view comprising:
at least two glass layers, an exterior and an interior glass layers;
at least one plastic bonding layer serving to bond opposite major faces of adjacent layers in the laminate, said at least one bonding layer being located between the exterior and the interior glass layers;
a resistive heating circuit configured to heat at least a portion of the camera field of view;
at least one adhesive layer; and
a transparent glass cover bonded to the interior glass layer by means of said at least one adhesive layer;
wherein the resistive heating circuit is located between the transparent glass cover and the interior glass layer.

2. The laminate of claim 1 wherein the resistive heating circuit is comprised of a micro-mesh deposited on the transparent glass cover.

3. The laminate of claim 1 wherein the resistive heating circuit is comprised of a transparent conductive coating deposited on the transparent cover.

4. The laminate of claim 1 wherein the transparent glass cover is chemically tempered.

5. The laminate of claim 1 wherein the transparent glass cover is cold bent.

6. The laminate of claim 1 wherein the transparent glass cover has a thickness of less than or equal to 1 mm thick, preferably less than or equal to 0.7 mm, more preferably less than or equal to 0.4 mm.

7. The laminate of claim 1 further comprising a plastic film, wherein the resistive heating circuit is comprised of a micro-mesh deposited on said plastic film, and wherein the plastic film is placed between the interior glass layer and the transparent glass cover.

8. The laminate of claim 1 further comprising a plastic film, wherein the resistive heating circuit is comprised of a transparent conductive coating deposited on said plastic film, and wherein the plastic film is placed between the interior glass layer and the transparent glass cover.

9. A laminated glazing with a camera field of view comprising:
at least two glass layers, an exterior and an interior glass layers, wherein the interior glass layer has a cutout in the camera field of view;
at least one plastic bonding layer serving to bond opposite major faces of adjacent layers in the laminate, said at least one bonding layer being located between the exterior and the interior glass layers;
a resistive heating circuit configured to heat at least a portion of the camera field of view; and
a transparent glass cover that fits within said cutout;
wherein the resistive heating circuit is located between the transparent glass cover and the exterior glass layer.

10. The laminate of claim 9 wherein the transparent glass cover is bonded to the exterior glass layer by means of said at least one plastic bonding layer.

11. The laminate of claim 9 further comprising at least one adhesive layer.

12. The laminate of claim 11 wherein said at least one plastic layer has a cut out in the camera field of view; and wherein the transparent glass cover is bonded to the exterior glass layer by means of said at least one adhesive layer.

13. The laminate of claim 9 wherein the resistive heating circuit is comprised of a micro-mesh deposited on the transparent glass cover.

14. The laminate of claim 9 wherein the resistive heating circuit is comprised of a transparent conductive coating deposited on the transparent cover.

15. The laminate of claim 9 wherein the transparent glass cover is chemically tempered.

16. The laminate of claim 9 wherein the transparent glass cover is cold bent.

17. The laminate of claim 9 wherein the transparent glass cover has a thickness of less than or equal to 1 mm thick, preferably less than or equal to 0.7 mm, more preferably less than or equal to 0.4 mm.

18. The laminate of claim 9 further comprising a plastic film, wherein the resistive heating circuit is comprised of a micro-mesh deposited on said plastic film, and wherein the plastic film is placed between the exterior glass layer and the transparent glass cover.

19. The laminate of claim 9 further comprising a plastic film, wherein the resistive heating circuit is comprised of a transparent conductive coating deposited on said plastic film, and wherein the plastic film is placed between the exterior glass layer and the transparent glass cover.
